(19) United States
(12) Patent Application Publication
(10) Pub. No.: US 2026/0336309 A1
(43) Pub. Date: Oct. 29, 2026

(54) DRYING DEVICE AND PRINTING SYSTEM

(71) Applicant: SEIKO EPSON CORPORATION, Tokyo (JP)

(72) Inventor: Katsuya ASAMOTO, MATSUMOTO-SHI (JP)

(21) Appl. No.: 19/657,577

(22) Filed: Apr. 24, 2026

(30) Foreign Application Priority Data
Apr. 25, 2025 (JP) 2025-073039

(51) Int. Cl. B41J 11/00

(52) U.S. Cl. CPC B41J 11/00216; B41J 11/00222; B41J 11/007

(57) ABSTRACT

A drying device includes: a transport unit that transports a medium having a first surface onto which a liquid is ejected, in a transport direction; a drying furnace through which the medium transported by the transport unit passes; a heating unit that is able to heat the medium from a side of the first surface in the drying furnace; and an exhaust unit that is disposed at a position on the other side of the heating unit from the medium in the drying furnace and exhausts air in the drying furnace. The heating unit includes a plurality of first heating sections located along the transport direction and a plurality of second heating sections located downstream of the plurality of first heating sections in the transport direction. An interval between the plurality of first heating sections in the transport direction is longer than an interval between the plurality of second heating sections in the transport direction.

The present application is based on, and claims priority from JP Application Serial Number 2025-073039, filed Apr. 25, 2025, the disclosure of which is hereby incorporated by reference herein in its entirety.

### BACKGROUND

### 1. Technical Field

The present disclosure relates to a drying device and a printing system.

### 2. Related Art

For example, as disclosed in JP-A-2020-002473, a drying device that heats and dries a recording medium in a drying chamber in order to dry a medium onto which a liquid is ejected from above is known. The drying device includes an infrared heater that is disposed in the drying chamber and heats the recording medium from below, and a suction unit that sucks vapor generated from the recording medium. The infrared heater and the suction unit are provided at positions sandwiching the recording medium. The infrared heater is an example of a heating unit.

JP-A-2020-002473 is an example of the related art.

However, in such a drying device, the heating unit heats, from below, the medium onto which the liquid is ejected from above. Therefore, there is a risk that the efficiency of heating the medium by the heating unit may decrease. Therefore, it is desired to improve the drying efficiency of the drying device.

### SUMMARY

According to an aspect of the present disclosure, a drying device includes: a transport unit that transports a medium having a first surface onto which a liquid is ejected, in a transport direction; a drying furnace through which the medium transported by the transport unit passes; a heating unit that is able to heat the medium from a side of the first surface in the drying furnace; and an exhaust unit that is disposed at a position on the other side of the heating unit from the medium in the drying furnace and exhausts air in the drying furnace, and the heating unit includes a plurality of first heating sections located along the transport direction and a plurality of second heating sections located downstream of the plurality of first heating sections in the transport direction, and an interval between the plurality of first heating sections in the transport direction is longer than an interval between the plurality of second heating sections in the transport direction.

According to another aspect of the present disclosure, a printing system includes: a printing unit that ejects a liquid and thus prints an image on a medium; a transport unit that transports a medium having a first surface onto which a liquid is ejected, in a transport direction; a drying furnace through which the medium transported by the transport unit passes; a heating unit that is able to heat the medium from a side of the first surface in the drying furnace; and an exhaust unit that is disposed at a position on the other side of the heating unit from the medium in the drying furnace and exhausts air in the drying furnace, and the heating unit includes a plurality of first heating sections located along the transport direction and a plurality of second heating sections located downstream of the plurality of first heating sections in the transport direction, and an interval between the plurality of first heating sections in the transport direction is longer than an interval between the plurality of second heating sections in the transport direction.

### BRIEF DESCRIPTION OF THE DRAWINGS

FIG. 1 is a schematic diagram illustrating a printing system according to a first embodiment.

FIG. 2 is a schematic diagram illustrating a drying device according to the first embodiment.

FIG. 3 is a schematic diagram illustrating a drying device according to a second embodiment.

FIG. 4 is a schematic diagram illustrating the drying device according to the second embodiment.

FIG. 5 is a flowchart showing heating unit moving processing according to the second embodiment.

### DESCRIPTION OF EMBODIMENTS

### First Embodiment

Hereinafter, an embodiment of a printing system including a printing device and a drying device will be described with reference to the drawings.

### Configuration of Printing System 11

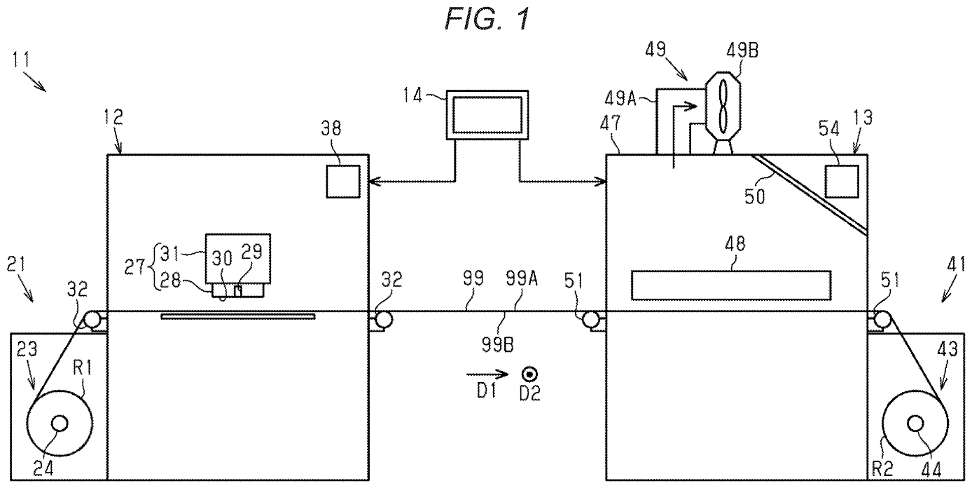

As illustrated in FIG. 1, a printing system 11 includes a printing device 12 and a drying device 13. The printing device 12 is configured to print an image on a medium 99. The printing device 12 is an inkjet printer that ejects an ink, which is an example of a liquid, onto the medium 99 such as a paper or cloth, and thus prints an image such as a character or photograph thereon. The medium 99 includes a first surface 99A and a second surface 99B. The first surface 99A is a surface onto which the liquid is ejected. The second surface 99B is a surface opposite to the first surface 99A. The second surface 99B may be a surface onto which the liquid is not ejected. The drying device 13 is configured to dry the medium 99 on which printing is done. Specifically, the drying device 13 dries the medium 99 by heating the medium 99. The printing system 11 performs printing and drying on the medium 99, which is a long medium extending over the printing device 12 and the drying device 13. The printing device 12 and the drying device 13 transmit signals to each other and thus cooperate with each other.

The printing device 12 and the drying device 13 are arranged along a transport direction D1. The transport direction D1 is a direction in which the medium 99 is transported from the printing device 12 to the drying device 13. The printing device 12 and the drying device 13 are arranged at an interval in the transport direction D1.

The printing system 11 includes an input unit 14. The input unit 14 is an interface for inputting information to the printing system 11. The user operates the input unit 14 and thus operates the printing system 11. The input unit 14 is, for example, a touch panel. The input unit 14 may include a button, a lever, a switch, and the like. The input unit 14 may be attached to the printing device 12 or may be attached to the drying device 13. The input unit 14 may be provided in the printing device 12 or may be provided in the drying device 13. The input unit 14 may be provided in each of the printing device 12 and the drying device 13.

The printing system 11 may include an unwinding unit 21. The unwinding unit 21 is configured to unwind the medium 99. The unwinding unit 21 unwinds the medium 99 from a roll body, for example. The roll body is an article formed of the medium 99 that is wound up.

The unwinding unit 21 includes an unwinding section 23. The unwinding section 23 unwinds the medium 99 from a first roll body R1. The first roll body R1 is a roll body formed of the medium 99 before printing that is wound up. The unwinding section 23 includes an unwinding shaft 24. The unwinding shaft 24 rotatably supports the first roll body R1. The unwinding shaft 24 may actively rotate or may be passively rotated. As the first roll body R1 rotates, the medium 99 is unwound from the first roll body R1. In the unwinding section 23, the first roll body R1 may rotate due to the rotation of the unwinding shaft 24, or may rotate due to the medium 99 being pulled.

The printing device 12 is configured to perform printing on the medium 99. The printing device 12 performs printing on the medium 99 sent out from the unwinding unit 21. The printing device 12 may perform printing on the medium 99 sent out from another device.

The printing device 12 has a printing unit 27. That is, the printing system 11 includes the printing unit 27. The printing unit 27 prints an image on the medium 99. The printing unit 27 performs printing on the medium 99 by ejecting a liquid onto the medium 99. The printing unit 27 performs printing on the medium 99 sent out from the unwinding section 23. The printing unit 27 performs printing on the transported medium 99.

The printing unit 27 includes a head 28. The head 28 has a nozzle surface 30 on which one or more nozzles 29 are open. The head 28 ejects the liquid from the nozzle 29 onto the medium 99. The nozzle surface 30 faces the first surface 99A of the medium 99.

The printing unit 27 may include a carriage 31. The head 28 is mounted on the carriage 31. The carriage 31 scans the medium 99. That is, the head 28 is a serial head that scans the medium 99 and thus performs printing over the width of the medium 99. The head 28 may be a line head that is able to simultaneously eject the liquid over the width of the medium 99.

The printing device 12 includes a print transport unit 32. The print transport unit 32 is configured to transport the medium 99. The print transport unit 32 transports the medium 99. The print transport unit 32 transports the medium 99 in the transport direction D1. The print transport unit 32 intermittently transports the medium 99. The print transport unit 32 may continuously transport the medium 99.

The print transport unit 32 transports the medium 99 sent out from the unwinding section 23. The print transport unit 32 may pull the medium 99 from the first roll body R1 and thus cause the unwinding section 23 to unwind the medium 99. The print transport unit 32 faces the second surface 99B of the medium 99. The print transport unit 32 is located directly below the medium 99.

The printing device 12 has a print control unit 38. The print control unit 38 may be provided in the printing system 11. The print control unit 38 controls the printing device 12. Specifically, the print control unit 38 controls the printing unit 27 and the print transport unit 32. The print control unit 38 may control the unwinding unit 21 in addition to the printing device 12. The print control unit 38 may control, for example, the unwinding section 23.

The print control unit 38 may be configured with one or more processors that execute various kinds of processing according to computer programs. The print control unit 38 may include one or more dedicated hardware circuits such as an application-specific integrated circuit that executes at least a part of the various kinds of processing. The print control unit 38 may be configured with a circuit including a combination of a processor and a hardware circuit. The processor includes a CPU and a memory such as a RAM and a ROM. The memory stores program codes or commands configured to cause the CPU to execute processing. The memory, that is, a computer-readable medium, includes any readable medium that can be accessed by a general-purpose or dedicated computer.

The print control unit 38 communicates with the drying device 13. The print control unit 38 may transmit various signals to the drying device 13. The print control unit 38 notifies the drying device 13 of the state of the printing device 12 by transmitting a signal thereto. The print control unit 38 receives various signals from the drying device 13. The print control unit 38 can grasp the state of the drying device 13 by receiving a signal from the drying device 13.

The printing system 11 includes a take-up unit 41. The take-up unit 41 is configured to wind up the medium 99. The take-up unit 41 forms a roll body by winding up the medium 99.

The take-up unit 41 includes a take-up section 43. The take-up section 43 winds up the medium 99. Specifically, the take-up section 43 winds up the medium 99 that is already dried. The take-up section 43 includes a take-up shaft 44. The take-up shaft 44 rotatably supports a second roll body R2. The second roll body R2 is a roll body formed of the medium 99 that is already dried and wound up. As the take-up shaft 44 rotates, the medium 99 is wound up thereon. That is, as the take-up shaft 44 rotates, the second roll body R2 rotates. The medium 99 is wound up by the take-up section 43 and thus transported in the drying device 13.

### Configuration of Drying Device 13

The drying device 13 is configured to dry the medium 99. The drying device 13 dries the medium 99 on which printing is done by the printing device 12. The medium 99 is dried by the drying device 13 and is subsequently wound up by the take-up unit 41.

The drying device 13 includes a drying furnace 47. That is, the printing system 11 includes the drying furnace 47. The medium 99 on which printing is done enters the drying furnace 47. The medium 99 transported from the printing device 12 enters the drying furnace 47. The medium 99 transported by the printing transport unit 32, a transport unit 51, described later, and the take-up section 43 passes through the drying furnace 47.

The drying device 13 includes a heating unit 48. That is, the printing system 11 includes the heating unit 48. The heating unit 48 is housed in the drying furnace 47. The heating unit 48 heats the medium 99 so as to maintain the medium 99 in a high-temperature state in order to dry the medium 99. The heating unit 48 is provided on the first surface 99A side. The heating unit 48 can heat the medium 99 from the first surface 99A side in the drying furnace 47.

The drying device 13 includes an exhaust unit 49. That is, the printing system 11 includes the exhaust unit 49. The exhaust unit 49 exhausts air in the drying furnace 47. The exhaust unit 49 is disposed at a position on the other side of the heating unit 48 from the medium 99 in the drying furnace 47. In particular, the exhaust unit 49 is disposed at a position on the other side of a first heating section 63, described later, from the medium 99 in the drying furnace 47.

The exhaust unit 49 includes an exhaust duct 49A. The exhaust duct 49A is a duct for exhausting air from the drying furnace 47. The exhaust duct 49A extends from the drying furnace 47. The exhaust duct 49A is attached to the drying furnace 47. The exhaust duct 49A is attached to the upper surface of the drying furnace 47.

The exhaust unit 49 may include an exhaust fan 49B. The exhaust fan 49B is a fan that exhausts air from the drying furnace 47. The exhaust fan 49B exhausts air from the drying furnace 47 through the exhaust duct 49A. The exhaust fan 49B is attached to the drying furnace 47. The exhaust fan 49B is attached to the upper surface of the drying furnace 47. The exhaust fan 49B is attached to the exhaust duct 49A. The exhaust fan 49B may be located outside the exhaust duct 49A or may be located inside the exhaust duct 49A.

The drying device 13 may include an exhaust guide member 50. The exhaust guide member 50 is provided to be able to guide the vapor generated when the liquid printed on the medium 99 is evaporated by the heating unit 48, to the exhaust unit 49. In particular, the exhaust guide member 50 is provided to be able to guide the vapor generated in a second heating region 62, described later, to the exhaust unit 49. The exhaust guide member 50 may be provided to be able to guide the vapor generated in a first heating region 61 to the exhaust unit 49. The exhaust guide member 50 is provided downstream in the transport direction D1 in the drying furnace 47, but may be provided upstream in the transport direction D1.

The exhaust guide member 50 may have any shape as long as it can guide the vapor generated by the heating unit 48 to the exhaust unit 49. The exhaust guide member 50 may be, for example, a linear member extending obliquely toward the exhaust unit 49 along a width direction D2, or may be a curved member. The width direction D2 is a direction intersecting the transport direction D1. The width direction D2 is a direction serving as an indicator indicating the width of the medium 99.

The drying device 13 includes a transport unit 51. That is, the printing system 11 includes the transport unit 51. The transport unit 51 is configured to transport the medium 99. The transport unit 51 transports the medium 99 in the transport direction D1. The transport unit 51 intermittently transports the medium 99. The transport unit 51 may continuously transport the medium 99. The transport speed of the print transport unit 32 and the transport speed of the transport unit 51 may be the same.

The transport unit 51 transports the medium 99 sent out from the unwinding section 23. The transport unit 51 transports the medium 99 to the take-up section 43. The transport unit 51 may pull the medium 99 from the first roll body R1 and thus cause the unwinding section 23 to unwind the medium 99. The medium 99 may be wound up by the take-up section 43 after being transported by the transport unit 51. The transport unit 51 may face the second surface 99B of the medium 99. The transport unit 51 may be located directly below the medium 99. The transport unit 51 may be, for example, one or more drying guide rollers. The drying guide roller may be located inside the drying furnace 47 or may be located outside the drying furnace 47.

The drying device 13 includes a control unit 54. The control unit 54 may be provided in the printing system 11. The control unit 54 controls the drying device 13. Specifically, the control unit 54 controls the heating unit 48, the exhaust fan 49B, and the transport unit 51. The control unit 54 may control the take-up unit 41 in addition to the drying device 13. For example, the control unit 54 may control the take-up section 43. The control unit 54 may be configured with a processor, a hardware circuit, or a circuit including a combination thereof, similarly to the print control unit 38.

The control unit 54 may communicate with the printing device 12. The control unit 54 communicates with the print control unit 38. Specifically, the control unit 54 receives various signals from the print control unit 38. The control unit 54 can grasp the state of the printing device 12 by receiving a signal from the print control unit 38. The control unit 54 may transmit various signals to the print control unit 38. The control unit 54 notifies the print control unit 38 of the state of the drying device 13 by transmitting a signal thereto.

### Configuration of Heating Unit 48

Next, the heating unit 48 will be described.

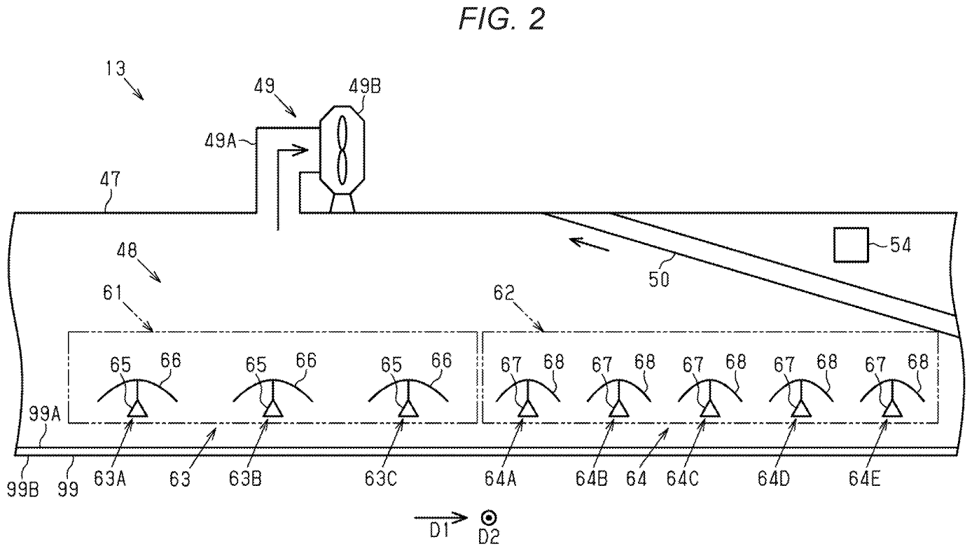

As shown in FIG. 2, the heating unit 48 includes a first heating region 61 and a second heating region 62. The first heating region 61 and the second heating region 62 are located on the first surface 99A side of the medium 99. The first heating region 61 is located upstream of the second heating region 62 in the transport direction D1.

The first heating region 61 is a region for vaporizing water contained in the liquid ejected onto the medium 99. The first heating region 61 is a region where the medium 99 is heated so as to quickly increase the temperature of the liquid printed on the medium 99 to about 100 degrees. The first heating region 61 is a region where the medium 99 is heated at a temperature at which the medium 99 is less likely to deteriorate.

The second heating region 62 is a region for vaporizing the solvent contained in the liquid ejected onto the medium 99. For example, when the liquid is a pigment ink, the second heating region 62 is a region where the medium 99 is heated such that the medium 99 is maintained at 150 degrees or higher in order to suppress the deterioration of the medium 99.

For example, when the medium 99 is a mixed fabric of 65% polyester and 35% cotton, the medium 99 may deteriorate when the temperature exceeds 170 degrees. For example, when the temperature of the medium 99 exceeds 170 degrees, the medium 99 may turn yellow. Therefore, a second heating section 64 heats the medium 99 such that the medium 99 is maintained at 150 degrees or higher and 170 degrees or lower. A first heating section 63 may have a set temperature higher than that of the second heating section 64.

The heating unit 48 includes a plurality of heating sections 63A to 63C and 64A to 64E. Specifically, the heating unit 48 includes a plurality of first heating sections 63. The heating unit 48 may include, for example, three heating sections 63A to 63C as the plurality of first heating sections 63. The plurality of first heating sections 63 are provided in the first heating region 61. The plurality of first heating sections 63 are located along the transport direction D1.

The heating unit 48 includes a plurality of second heating sections 64. The heating unit 48 may include, for example, five heating sections 64A to 64E as the plurality of second heating sections 64. As described above, the number of the first heating sections 63 may be smaller than the number of the second heating sections 64. The plurality of second heating sections 64 are provided in the second heating region 62. The plurality of second heating sections 64 are located along the transport direction D1. The plurality of second heating sections 64 are located downstream of the plurality of first heating sections 63 in the transport direction D1.

Each of the plurality of first heating sections 63 includes a first infrared heater 65. The first infrared heater 65 extends in the width direction D2 and thus irradiates the medium 99 over the width thereof with infrared rays. The first infrared heater 65 is controlled by the control unit 54 to irradiate the medium 99 with infrared rays from the first surface 99A side. Each of the plurality of first heating sections 63 may drive the first infrared heater 65 at an individually set temperature. Each of the plurality of first heating sections 63 includes a first reflection plate 66. The first reflection plate 66 reflects the heat of the first infrared heater 65 to the medium 99.

Each of the plurality of second heating sections 64 includes a second infrared heater 67. The second infrared heater 67 extends in the width direction D2 and thus irradiates the medium 99 over the width thereof with infrared rays. The second infrared heater 67 is controlled by the control unit 54 to irradiate the medium 99 with infrared rays from the first surface 99A side. Each of the plurality of second heating sections 64 may drive the second infrared heater 67 at an individually set temperature.

Each of the plurality of second heating sections 64 includes a second reflection plate 68. The second reflection plate 68 reflects the heat of the second infrared heater 67 to the medium 99. The second reflection plate 68 is smaller than the first reflection plate 66. That is, the first reflection plate 66 is larger than the second reflection plate 68.

The plurality of first heating sections 63 are disposed at equal intervals in the transport direction D1. The plurality of second heating sections 64 are disposed at equal intervals in the transport direction D1.

The interval between the plurality of first heating sections 63 in the transport direction D1 is longer than the interval between the plurality of second heating sections 64 in the transport direction D1. In particular, the interval between the plurality of first infrared heaters 65 in the transport direction D1 is longer than the interval between the plurality of second infrared heaters 67 in the transport direction D1. The interval between the first reflection plates 66 in the transport direction D1 is longer than the interval between the second reflection plates 68 in the transport direction D1.

### Functions and Effects of First Embodiment

Functions and effects of the first embodiment will be described.
(1-1) The heating unit 48 heats the medium 99 onto the first surface 99A of which the liquid is ejected, from the first surface 99A side. The exhaust unit 49 is disposed at a position on the other side of the heating unit 48 from the medium 99 in the drying furnace 47. The interval between the plurality of first heating sections 63 in the transport direction D1 is longer than the interval between the plurality of second heating sections 64 in the transport direction D1. According to this configuration, the efficiency of heating the medium 99 by the heating unit 48 can be improved as compared with when heating is performed from the second surface 99B side. In addition, the vapor of the liquid generated when the medium 99 is heated can more easily pass between the plurality of first heating sections 63 than between the plurality of second heating sections 64. Thus, the vapor of the liquid generated in the vicinity of the plurality of first heating sections 63 is more easily exhausted by the exhaust unit 49. Therefore, the exhaust efficiency can be improved. Thus, the drying efficiency of the drying device 13 can be improved.
(1-2) The number of the first heating sections 63 is smaller than the number of the second heating sections 64. According to this configuration, even when the interval between the plurality of first heating sections 63 in the transport direction D1 is longer than the interval between the plurality of second heating sections 64 in the transport direction D1, the installation distance of the plurality of first heating sections 63 in the transport direction D1 can be shortened. Thus, an increase in the size of the drying device 13 can be suppressed.
(1-3) The first reflection plate 66 is larger than the second reflection plate 68. According to this configuration, the heat of the first infrared heater 65 can be reflected in a wider range than the heat of the second infrared heater 67. Thus, even when the number of the first heating sections 63 is smaller than the number of the second heating sections 64, variations in the drying of the medium 99 can be made less likely to occur in the first heating region 61. Thus, the drying efficiency of the drying device 13 can be improved.
(1-4) The exhaust unit 49 is disposed at a position on the other side of the first heating section 63 from the medium 99 in the drying furnace 47. According to this configuration, the vapor of the liquid generated in the vicinity of the first heating section 63 is easily exhausted by the exhaust unit 49. Thus, the amount of moisture in the drying furnace 47 can be reduced and the vapor generated when the heating unit 48 heats the medium 99 can be prevented from being adsorbed to the medium 99 again. In particular, when a larger amount of vapor is generated in the first heating region 61 than in the second heating region 62, the vapor generated in the first heating region 61 is easily exhausted by the exhaust unit 49 and therefore the amount of vapor adsorbed on the medium 99 again can be reduced. Thus, the drying efficiency of the drying device 13 can be improved.

### Second Embodiment

Next, a second embodiment will be described. In the description below, the repeated description of the same configurations as those of the above-described embodiment will be omitted or simplified, and configurations different from those of the above-described embodiment will be described.

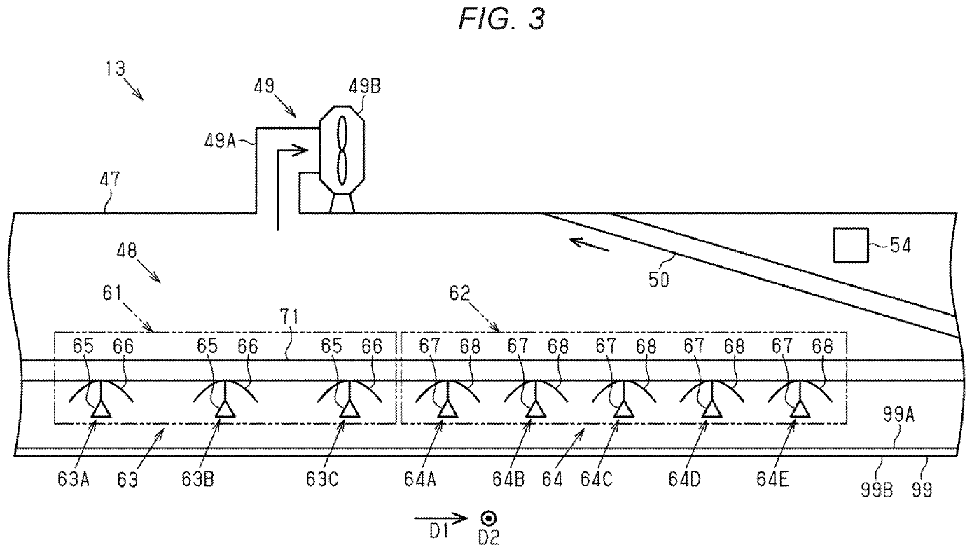

As illustrated in FIG. 3, in the second embodiment, the drying device 13 includes a moving unit 71. The moving unit 71 is provided along the transport direction D1 in the drying furnace 47. One moving unit 71 may be provided in the drying furnace 47, or two or more moving units 71 may be provided side by side in the width direction D2 in the drying furnace 47.

The moving unit 71 enables the movement of the heating sections 64A to 64E along the transport direction D1. The moving unit 71 may be, for example, a rail on which the heating sections 64A to 64E move along the transport direction D1. The moving unit 71 may include a drive unit, not illustrated, and a roller, not illustrated. The moving unit 71 may move the heating sections 64A to 64E by causing the drive unit, not illustrated, to rotate the roller, not illustrated.

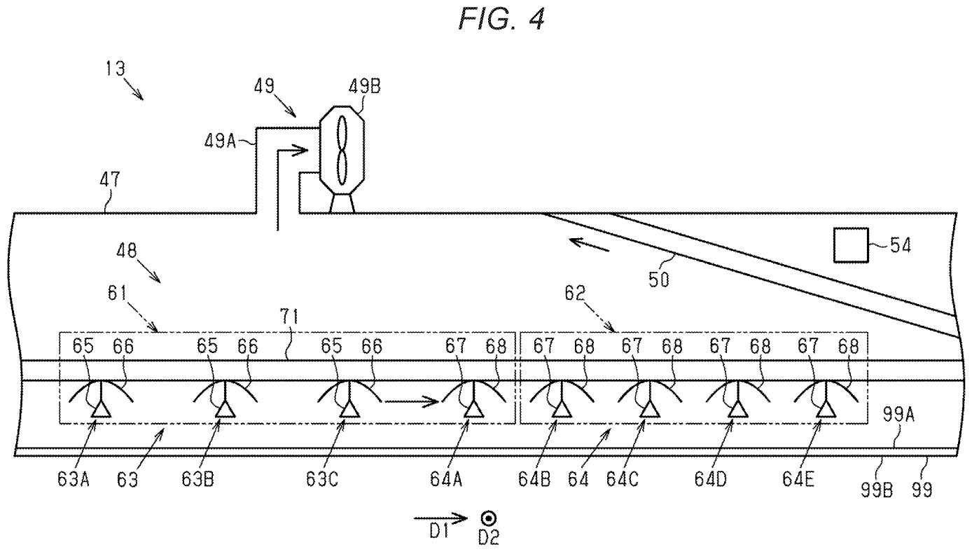

The moving unit 71 may move the heating sections 64A to 64E to a first position illustrated in FIG. 3, which is the same as in the first embodiment, and a second position illustrated in FIG. 4. The first position illustrated in FIG. 3 is a position where the three heating sections 63A to 63C are at the same interval in the transport direction D1 and this interval is longer than the interval between the five heating sections 64A to 64E in the transport direction D1.

The second position illustrated in FIG. 4 is a position where the three heating sections 63A to 63C and the one heating section 64A are at the same interval in the transport direction D1 and this interval is longer than the interval between the four heating sections 64B to 64E in the transport direction D1.

That is, at the first position, the one heating section 64A is allocated to the second heating region 62, whereas at the second position, the one heating section 64A is allocated to the first heating region 61. The temperature at which the one heating section 64A heats the medium 99 may be variable according to the region to which this heating section is allocated. The first reflection plate 66 may have the same size as the second reflection plate 68.

### Heating Unit Moving Processing

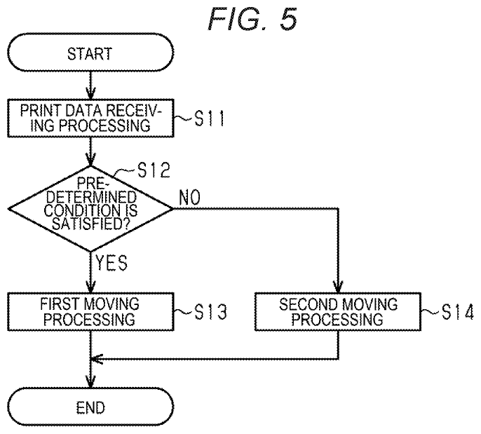

Heating unit moving processing will be described with reference to FIG. 5. The heating unit moving processing is processing executed by the control unit 54 every predetermined cycle.

In step S11, the control unit 54 executes print data receiving processing. In this processing, the control unit 54 receives the print data of the printing device 12 from the print control unit 38. The print data may include at least one of the type of the medium 99, the type of the liquid, the amount of the liquid to be discharged onto the medium 99, and the transport speed of the medium 99.

In step S12, the control unit 54 determines whether a predetermined condition is satisfied, based on the print data. In this processing, the control unit 54 may determine that the predetermined condition is satisfied, when it is determined from the print data that the amount of the liquid to be discharged onto the medium 99 is equal to or greater than a threshold value. The control unit 54 may determine that the predetermined condition is not satisfied, when it is determined from the print data that the amount of the liquid to be discharged is less than the threshold value.

The control unit 54 may determine that the predetermined condition is satisfied, when it is determined from the print data that the type of the medium 99 is a first medium type. The control unit 54 may determine that the predetermined condition is not satisfied, when it is determined from the print data that the type of the medium 99 is a second medium type. The first medium type is easier to dry than the second medium type.

The control unit 54 may determine that the predetermined condition is satisfied, when it is determined from the print data that the type of the liquid is a first liquid type. The control unit 54 may determine that the predetermined condition is not satisfied, when it is determined from the print data that the type of the liquid is a second liquid type. The first liquid type is easier to dry than the second liquid type.

The control unit 54 may determine that the predetermined condition is satisfied, when it is determined from the print data that the transport speed of the medium 99 is a first transport speed. The control unit 54 may determine that the predetermined condition is not satisfied, when it is determined from the print data that the transport speed of the medium 99 is a second transport speed. The first transport speed is lower than the second transport speed. The data used when the control unit 54 determines whether the predetermined condition is satisfied based on the print data may be any combination of the above conditions.

When it is determined that the predetermined condition is satisfied, the control unit 54 shifts the processing to step S13. When it is determined that the predetermined condition is not satisfied, the control unit 54 shifts the processing to step S14.

In step S13, the control unit 54 executes first moving processing. In this processing, the control unit 54 controls the moving unit 71 to move the heating sections 64A to 64E to the first position. The control unit 54 may not move the heating sections 64A to 64E when the heating sections 64A to 64E are already disposed at the first position.

In step S14, the control unit 54 executes second moving processing. In this processing, the control unit 54 controls the moving unit 71 to move the heating sections 64A to 64E to the second position. The control unit 54 may not move the heating sections 64A to 64E when the heating sections 64A to 64E are already disposed at the second position.

As described above, the control unit 54 controls the moving unit 71 to move the heating sections 64A to 64E along the transport direction D1, based on the print data from the printing device 12 that performs printing on the medium 99.

### Functions and Effects of Second Embodiment

Functions and effects of the second embodiment will be described.
(2-1) The moving unit 71 that enables the movement of the heating sections 64A to 64E along the transport direction D1 is provided. According to this configuration, the heating sections 64A to 64E can be moved along the transport direction D1. Thus, the ranges of the first heating region 61 and the second heating region 62 can be adjusted. Thus, the sizes of the first heating region 61 and the second heating region 62 can be adjusted. Therefore, the drying efficiency of the drying device 13 can be improved.
(2-2) The control unit 54 controls the moving unit 71, based on print data from the printing device 12 that performs printing on the medium 99. According to this configuration, the heating sections 64A to 64E can be moved, based on the print data from the printing device 12 that performs printing on the medium 99. For example, when a larger amount of liquid than usual is ejected onto the medium 99, the plurality of heating sections 64A to 64E are moved such that the heating section 64A is disposed in the first heating region 61. Thus, since the first heating region 61 is larger than the second heating region 62 in the transport direction D1, the medium 99 is dried in the first heating region 61 for a longer time than usual and therefore a larger amount of moisture than usual can be vaporized there. In this way, the drying device 13 can perform appropriate drying according to the printing status of the medium 99. Therefore, the drying efficiency of the drying device 13 can be improved.

### Modification Examples

The present embodiments can be implemented with the following modifications. The present embodiments and the following modification examples can be implemented in combination with each other as long as no technical inconsistencies are involved.

In the first embodiment, the plurality of first reflection plates 66 may have different sizes. The plurality of second reflection plates 68 may have different sizes. In the second embodiment, the first reflection plate 66 may be larger than the second reflection plate 68.

In the first embodiment, as long as the interval between the plurality of first heating sections 63 in the transport direction D1 is longer than the interval between the plurality of second heating sections 64 in the transport direction D1, the number of first heating sections 63 may be the same as the number of second heating sections 64, or may be larger than the number of second heating sections 64.

In the second embodiment, the moving unit 71 may move the heating sections 64A to 64E in response to the operation of the input unit 14 by the user. The heating sections 64A to 64E may be manually movable by the user.

In the second embodiment, the moving unit 71 may enable the movement of any one of the plurality of heating sections 63A to 63C and 64A to 64E along the transport direction D1. For example, the moving unit 71 may enable the movement of the heating section 64A such that the interval between the heating section 63C and the heating section 64A is the same as the interval between the plurality of first heating sections 63. The moving unit 71 may enable the movement of the heating section 63C such that the interval between the heating section 63C and the heating section 64A is the same as the interval between the plurality of second heating sections 64. As described above, the moving unit 71 may enable the movement of at least one of the plurality of first heating sections 63 and the plurality of second heating sections 64 along the transport direction D1. In the second embodiment, the plurality of first heating sections 63 and the plurality of second heating sections 64 may be configured to be independently movable.

In the first embodiment and the second embodiment, the heights of the plurality of first heating sections 63 and the plurality of second heating sections 64 with respect to the medium 99 may be adjustable.

The first heating region 61 and the second heating region 62 may have the same size or different sizes in the transport direction D1. The first heating region 61 may be a region larger than the second heating region 62.

The heating unit 48 may include the same number of controllers as the plurality of first heating sections 63 and the plurality of second heating sections 64.

The first infrared heater 65 and the second infrared heater 67 are not limited to a triangular shape when viewed from the width direction D2. The first infrared heater 65 and the second infrared heater 67 may be, for example, in a circular shape or a polygonal shape when viewed from the width direction D2.

The control unit 54 may have the function of the print control unit 38. In such a case, the printing system 11 may not include the print control unit 38 as long as the printing system 11 includes the control unit 54. The control unit 54 may acquire the print data by itself without communicating with the print control unit 38.

A lateral printer may be adopted as the printing device 12. The lateral printer is a printer in which the carriage 31 is movable in two directions of the transport direction D1 and the width direction D2. The printing device 12 may be configured to print an image by ejecting a liquid onto both surfaces of the medium 99.

Any liquid that adheres to the medium 99 to enable recording on the medium 99 can be freely selected. For example, the ink includes an ink formed by dissolving, dispersing, or mixing particles of a functional material configured with solid matters such as pigment or metal particles in a solvent, and includes various compositions such as an aqueous ink, an oil-based ink, a gel ink, and a hot melt ink.

The medium 99 is not limited to the roll body. The medium 99 may be a paper sheet, a resin film or resin sheet, a composite film of resin and metal, a laminated film, a woven fabric, a nonwoven fabric, a metal foil, a metal film, a ceramic sheet, clothing, or the like.

The expression “at least one of” used in the present specification means one or more of desired options. As an example, when the number of options is two, the expression “at least one of” used in the present specification means just one of the options or both of the two options. As another example, when the number of options is three or more, the expression “at least one of” used in the present specification means just one of the options or a combination of any two or more of the options.

### APPENDICES

Technical ideas understood from the above-described embodiments and modification examples, and the functions and effects thereof will hereinafter be described. The technical ideas, and the functions and effects thereof can be combined with each other within a range where no technical contradictions are involved.
[1] A drying device includes: a transport unit that transports a medium having a first surface onto which a liquid is ejected, in a transport direction; a drying furnace through which the medium transported by the transport unit passes; a heating unit that is able to heat the medium from a side of the first surface in the drying furnace; and an exhaust unit that is disposed at a position on the other side of the heating unit from the medium in the drying furnace and exhausts air in the drying furnace, and the heating unit includes a plurality of first heating sections located along the transport direction and a plurality of second heating sections located downstream of the plurality of first heating sections in the transport direction, and an interval between the plurality of first heating sections in the transport direction is longer than an interval between the plurality of second heating sections in the transport direction.

According to this configuration, since the heating unit heats the medium with the liquid ejected onto the first surface thereof, from the first surface side, the efficiency of heating the medium by the heating unit can be made higher than when the heating is performed from the side opposite to the first surface. In addition, since the interval between the plurality of first heating sections in the transport direction is longer than the interval between the plurality of second heating sections in the transport direction, the vapor of the liquid generated when the medium is heated can easily pass between the plurality of first heating sections. Thus, the vapor of the liquid generated in the vicinity of the plurality of first heating sections is easily exhausted by the exhaust unit. Therefore, the drying efficiency of the drying device can be improved.
[2] In the drying device, the number of the first heating sections is smaller than the number of the second heating sections. According to this configuration, the interval between the plurality of first heating sections in the transport direction can be made longer than the interval between the plurality of second heating sections in the transport direction. Therefore, the vapor of the liquid generated when the medium is heated easily passes between the plurality of first heating sections. Thus, the vapor of the liquid generated in the vicinity of the plurality of first heating sections is easily exhausted by the exhaust unit. Therefore, the drying efficiency of the drying device can be improved.
[3] In the drying device, each of the plurality of first heating sections includes a first infrared heater and a first reflection plate that reflects heat of the first infrared heater to a medium, each of the plurality of second heating sections includes a second infrared heater and a second reflection plate that reflects heat of the second infrared heater to the medium, and the first reflection plate is larger than the second reflection plate.

According to this configuration, the heat of the first infrared heater can be reflected in a wider range. Thus, even when the number of the plurality of first heating sections is smaller than the number of the plurality of second heating sections, variations in the drying of the medium can be made less likely to occur in the first heating region. Therefore, the drying efficiency of the drying device can be improved.
[4] In the drying device, the exhaust unit is disposed at a position on the other side of the first heating section from the medium in the drying furnace. According to this configuration, the vapor of the liquid generated in the vicinity of the first heating section is easily exhausted by the exhaust unit. Thus, the amount of moisture in the drying furnace can be reduced. Therefore, the drying efficiency of the drying device can be improved.
[5] The drying device further includes a moving unit that enables the movement of at least one of the plurality of first heating sections and the plurality of second heating sections along the transport direction. According to this configuration, the heating unit can be moved along the transport direction. Thus, the ranges of the first heating region and the second heating region can be adjusted in the transport direction.
[6] The drying device further includes a control unit, and the control unit controls the moving unit, based on print data from a printing device that performs printing on a medium. According to this configuration, the heating sections can be moved, based on the print data from the printing device that performs printing on the medium. Thus, appropriate drying can be performed according to the printing status of the medium. Therefore, the drying efficiency of the drying device can be improved.
[7] A printing system includes: a printing unit that ejects a liquid and thus prints an image on a medium; a transport unit that transports a medium having a first surface onto which a liquid is ejected, in a transport direction; a drying furnace through which the medium transported by the transport unit passes; a heating unit that is able to heat the medium from a side of the first surface in the drying furnace; and an exhaust unit that is disposed at a position on the other side of the heating unit from the medium in the drying furnace and exhausts air in the drying furnace, and the heating unit includes a plurality of first heating sections located along the transport direction and a plurality of second heating sections located downstream of the plurality of first heating sections in the transport direction, and an interval between the plurality of first heating sections in the transport direction is longer than an interval between the plurality of second heating sections in the transport direction. According to this configuration, the same effects as the effects in [1] can be achieved.

What is claimed is:

1. A drying device comprising:
a transport unit that transports a medium having a first surface onto which a liquid is ejected, in a transport direction;
a drying furnace through which the medium transported by the transport unit passes;
a heating unit that is able to heat the medium from a side of the first surface in the drying furnace; and
an exhaust unit that is disposed at a position on the other side of the heating unit from the medium in the drying furnace and exhausts air in the drying furnace, wherein
the heating unit includes a plurality of first heating sections located along the transport direction and a plurality of second heating sections located downstream of the plurality of first heating sections in the transport direction, and
an interval between the plurality of first heating sections in the transport direction is longer than an interval between the plurality of second heating sections in the transport direction.

2. The drying device according to claim 1, wherein
a number of the first heating sections is smaller than a number of the second heating sections.

3. The drying device according to claim 1, wherein
each of the plurality of first heating sections includes a first infrared heater and a first reflection plate that reflects heat of the first infrared heater to a medium,
each of the plurality of second heating sections includes a second infrared heater and a second reflection plate that reflects heat of the second infrared heater to the medium, and
the first reflection plate is larger than the second reflection plate.

4. The drying device according to claim 1, wherein
the exhaust unit is disposed at a position on the other side of the first heating section from the medium in the drying furnace.

5. The drying device according to claim 1, further comprising:
a moving unit that enables a movement of at least one of the plurality of first heating sections and the plurality of second heating sections along the transport direction.

6. The drying device according to claim 5, further comprising:
a control unit, wherein
the control unit controls the moving unit, based on print data from a printing device that performs printing on a medium.

7. A printing system comprising:
a printing unit that ejects a liquid and thus prints an image on a medium;
a transport unit that transports a medium having a first surface onto which a liquid is ejected, in a transport direction;
a drying furnace through which the medium transported by the transport unit passes;
a heating unit that is able to heat the medium from a side of the first surface in the drying furnace; and
an exhaust unit that is disposed at a position on the other side of the heating unit from the medium in the drying furnace and exhausts air in the drying furnace, wherein
the heating unit includes a plurality of first heating sections located along the transport direction and a plurality of second heating sections located downstream of the plurality of first heating sections in the transport direction, and
an interval between the plurality of first heating sections in the transport direction is longer than an interval between the plurality of second heating sections in the transport direction.
